(19) United States
(12) Patent Application Publication
(10) Pub. No.: US 2018/0194217 A1
(43) Pub. Date: Jul. 12, 2018

(54) DEVICE FOR SEALING A FRONT-END AIR INTAKE OF A MOTOR VEHICLE

(71) Applicant: Valeo Systemes Thermiques, Le Mesnil Saint Denis (FR)

(72) Inventors: Frédéric Vacca, Le Mesnil Saint-Denis (FR); Christophe Thullier, Le Mesnil Saint-Denis (FR)

(73) Assignee: Valeo Systemes Thermiques, Le Mesnil Saint Denis (FR)

(21) Appl. No.: 15/738,740

(22) PCT Filed: Jun. 1, 2016
(86) PCT No.: PCT/EP2016/062424

§ 371 Date: Dec. 21, 2017

(30) Foreign Application Priority Data
Jun. 26, 2015 (FR) 1555917

(51) Int. Cl. B60K 11/08

(52) U.S. Cl. CPC B60K 11/085

(57) ABSTRACT

The present invention relates to a sealing device (1) in particular for a front-end air intake of a motor vehicle, which comprises: a supporting frame (5) in which at least one flap (3) is installed, swivelling about a horizontal swivel pin (A) between a sealing position and an open position, at least one control element (13) controlling the position of the one or more flaps (3), the lower portion of the supporting frame (5) and the lower end of the flap (3) that is lowest when said flap (3) is in the sealing position being separated by a space (E).

The present invention relates to sealing-off devices and, more particularly, to a device for sealing off the front-end air intake of a motor vehicle.

Motor vehicle front ends are generally made up of two main air intakes referred to as the top route and the bottom route, which are separated by a bumper beam. The heat exchangers of the motor vehicle, such as, for example, the one used for vehicle interior air conditioning or alternatively the one used for engine cooling, are generally positioned behind this bumper beam.

It is also known practice to place, in the path of air passing through the main air intakes, more generally the bottom route, a support frame comprising a multitude of flaps mounted with the ability to pivot about parallel axes and able to adopt a multitude of different angular positions comprised between an open position and a sealing-off position, under the action of suitable control means.

In this way a sealing-off device is obtained that can be likened to a louver blind that makes it possible to adjust the flow rate of air passing through the air intakes and arriving at the heat exchangers, and thus to optimize the efficiency of these heat exchangers according to need. In addition, at high speed, having the flaps in the sealing-off position makes it possible to reduce the coefficient of drag of the vehicle and thus improve its aerodynamics.

In general, the device that allows the flaps to pass from a sealing-off position into an open position comprises an actuator which may be mechanical, electrical or even pneumatic, causing the flaps to pivot in synchronicity with one another by means of a pivot link.

Under winter or cold, damp conditions, when the vehicle is stationary, water may run along the flaps and accumulate in the lower part of the support frame. This water may freeze, for example when the vehicle is parked, and thus block the flaps notably through an accumulation of ice thus preventing them from pivoting. This same icing phenomenon may also occur between the flaps themselves, and this may likewise immobilize them.

In order for the flaps not to become blocked by this ice, it is known practice for the sealing-off device to be provided with a control means that is able to deploy sufficient force to break the ice formed and with flaps that are sufficiently strong.

However, that entails increasing the size of the control means so that it is powerful and strong enough, and that in fact increases the cost thereof. The same is true of the flaps which need to be stronger and therefore are more expensive.

One of the objects of the present invention is therefore to at least partially overcome the disadvantages of the prior art and propose an improved sealing-off device.

The present invention therefore relates to a sealing-off device in particular for the air intake of the front end of a motor vehicle, comprising:
a support frame in which there is installed at least one pivoting flap pivoting about a horizontal axis of pivoting between a sealing-off position and an open position,

at least one control element controlling the positioning of the flap or flaps, the lower part of the support frame and the lower end of the flap situated lowest down when said flap is in the sealing-off position being separated by a space.

This space, because of its height, makes it possible to collect any water that may run off out of the device when the motor vehicle is stationary. This water does not accumulate at the lowermost flap which means that if this water freezes, it does not block said flap. It is thus possible to manufacture a sealing-off device with a control element of lower power and strength, which is therefore less expensive.

According to one aspect of the invention, said sealing-off device comprises a fixed wall, said fixed wall being positioned at the space between the lower part of the support frame and the lower end of the flap situated lowest down.

According to another aspect of the invention, the fixed wall is substantially parallel to the flap situated lowest down when said flap is in the sealing-off position.

According to another aspect of the invention, the height of the fixed wall is comprised between 10 and 15 mm.

According to another aspect of the invention, the fixed wall forms a single-piece component with the lower part of the support frame.

According to another aspect of the invention, the lower part of the support frame has the overall shape of an L.

According to another aspect of the invention, when the motor vehicle is stationary, the flap or flaps position themselves in a predetermined stopping position in which the said flap or flaps are offset by an angle comprised between 1 and 40° with respect to their sealing-off position.

According to another aspect of the invention, when the motor vehicle is stationary, the flap situated lowest down positions itself in a predetermined stopping position resting against the fixed wall.

Further features and advantages of the invention will become more clearly apparent from reading the following description, given by way of nonlimiting illustrative example, and from studying the attached drawings in which:

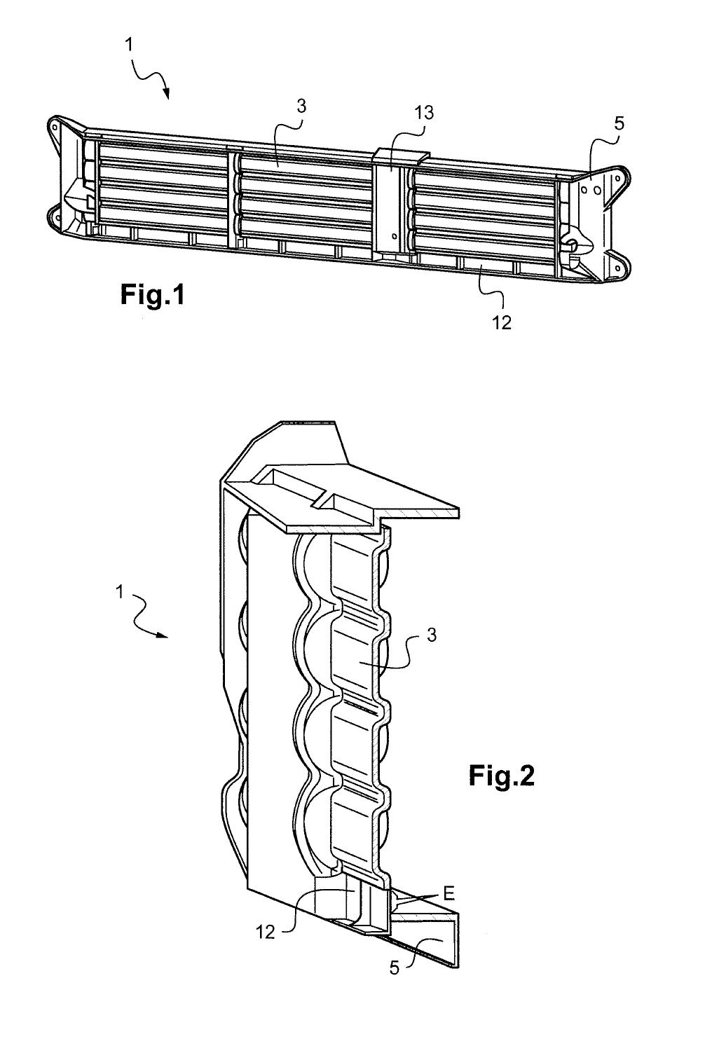

FIG. 1 is a schematic front-perspective depiction of a sealing-off device in the sealing-off position,

FIG. 2 is a schematic depiction in perspective and in cross section of the sealing-off device of FIG. 1,

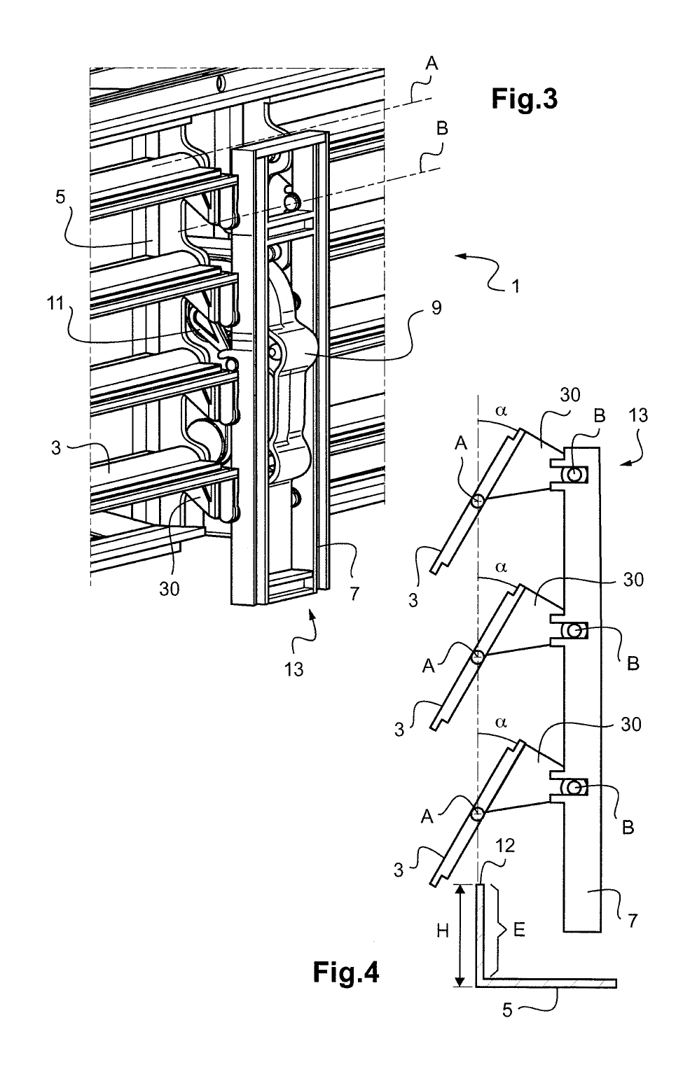

FIG. 3 is a schematic and perspective depiction of a control element,

FIG. 4 is a schematic depiction from the side and in cross section of a sealing-off device.

Identical elements in the various figures bear the same references.

The following embodiments are examples. Although the description refers to one or more embodiments, that does not necessarily mean that each reference relates to the same embodiment or that the features apply only to one single embodiment. Simple features of various embodiments can also be combined to make other embodiments.

FIG. 1 is a schematic depiction, in perspective, of a sealing-off device in the sealing-off position. This FIG. 1 more precisely shows the external face of said sealing-off device 1, that is to say the face that faces toward the outside of the motor vehicle.

Said sealing-off device 1 comprises a support frame 5 on which at least one flap 3 is installed. When there are a plurality of flaps 3, these form mutually-parallel rows of flaps 3. At one of the ends of the flap or flaps 3 is positioned a control element 13 that allows the flap or flaps 3 to be rotated between an open position, in which the flaps 3 are arranged in such a way that a flow of air can pass through the sealing-off device 1, notably inside the support frame 5, and a sealing-off position illustrated in FIGS. 1 and 2, in which the flaps are arranged in such a way that a flow of air cannot pass through the sealing-off device 1.

As illustrated in FIG. 1, it is possible to have a sealing-off device 1 for a motor vehicle front-end air intake that comprises at least two sets of flaps 3 extending across the entire width of the support frame 5. Two sets of flaps 3 may thus be separated by a control element 13 so as to ensure they rotate in synchronicity.

As FIG. 3 shows, the control assembly 13 notably comprises a pivot link 7 connected to the flaps 3 by a rib 30 perpendicular to said flaps 3, generally formed as one piece with said flaps 3 and bearing a connecting pin B.

The control element 13 also comprises an actuator 9. The actuator 9 may be electrical, such as, for example, an electric motor, or alternatively pneumatic, such as, for example, an actuating cylinder. Said actuator 9 applies an upward or downward translational movement to the pivot link 7, in this instance by means of a lever 11.

The flaps 3 may pivot about an axis of pivoting A defined by their connection to the support frame 5. Because the connecting pin B that connects the flaps 3 to the link 7 is offcentered with respect to the axis of pivoting A, an upward or downward movement of the link 7, under the action of the actuator 9, causes the flaps 3 to pivot about the axis of pivoting A and therefore causes said flaps 3 to move from one position to another.

Because all of the flaps 3 are connected to the same pivot link 7, the movement from an open position to a closing-off position is synchronous for all said flaps 3. It is also possible for the set to comprise just one single flap 3.

As illustrated in FIGS. 1, 2 and 4, said sealing-off device 1 comprises, between the lower part of the support frame 5 and the lower end of the flap 3 situated lowest down, a space E. This space E makes it possible to collect and/or remove any water that may run off when the motor vehicle is stationary. This water does not collect at the flap 3 situated lowest down and so if it freezes, it does not block said flap 3. It is thus possible to manufacture a sealing-off device 1 with a control element 13 of lower power and strength which is therefore less expensive.

The space E between the lower part of the support frame 5 and the lower end of the flap 3 situated lowest down may notably be filled by a fixed wall 12. This fixed wall 12 is parallel to the flap 3 situated lowest down when said flap 3 is in the sealing-off position, and said fixed wall 12 has a height H of at least 10 mm. Of course, the space E has the same height, or in other words, the lower part of the support frame and the lower end of the flap situated lowest down, when said flap is in the sealing-off position, are separated by a space of at least 10 mm.

For preference, the height H of the fixed wall 12 is comprised between 10 and 15 mm. That allows water to be collected while at the same time keeping the support frame 5 of the sealing-off device 1 reasonably compact.

As illustrated in FIGS. 2 and 4 in cross section, the lower part of the support frame 5 may have the overall shape of an L so as to press the fixed wall 12 between the lower part of the support frame 5 and the lower end of the flap 3 situated lowest down, when said flap 3 is in the sealing-off position.

The fixed wall 12 may form a single-piece component with the lower part of the support frame 5 and thus be manufactured at the same time as the support frame 5.

According to one first embodiment, when the motor vehicle is stationary, the flap or flaps 3 position themselves in a predetermined stopping position. In order for water not to be able to accumulate and freeze between the flaps 3 in this predetermined stopping position, the flaps 3 may be offset by an angle a of between 1 and 40° with respect to their sealing-off position.

This inclination prevents water from collecting between the flaps 3 and, if this water should freeze, prevents the flaps from being stuck together. It is thus possible to use flaps 3 that are less strong and more lightweight and therefore less expensive in the manufacture of the sealing-off device 1.

According to a second embodiment, when the motor vehicle is stationary, the flap 3 situated lowest down positions itself in a predetermined stopping position resting against the fixed wall 12.

Thus, it can be clearly seen that, because of the presence of the space E between the lower part of the support frame 5 and the lower end of the flap 3 situated lowest down, when said flap 3 is in the sealing-off position, but also because of the fact that, in the predetermined stopping position, the flaps 3 may make an angle a of between 1 and 10° with respect to their sealing-off position, the sealing-off device 1 according to the invention prevents the flaps 3 from being blocked by ice and it is therefore possible to manufacture a sealing-off device 1 for a lower cost because its requirements in terms of robustness and power are lower.

1. A sealing-off device for the air intake of the front end of a motor vehicle, comprising:
a support frame in which there is installed at least one pivoting flap pivoting about a horizontal axis of pivoting between a sealing-off position and an open position; and
at least one control element governing the positioning of the flap or flaps, wherein the lower part of the support frame and the lower end of the flap situated lowest down when said flap is in the sealing-off position are separated by a space.

2. The sealing-off device as claimed in claim 1, wherein said sealing-off device comprises a fixed wall, said fixed wall being positioned at the space between the lower part of the support frame and the lower end of the flap situated lowest down.

3. The sealing-off device as claimed in claim 2, wherein the fixed wall is substantially parallel to the flap situated lowest down when said flap is in the sealing-off position.

4. The sealing-off device as claimed in claim 2, wherein the height of the fixed wall is comprised between 10 and 15 mm.

5. The sealing-off device as claimed in claim 2, wherein the fixed wall forms a single-piece component with the lower part of the support frame.

6. The sealing-off device as claimed in claim 1, wherein the lower part of the support frame has the overall shape of an L.

7. The sealing-off device as claimed in claim 1, wherein when the motor vehicle is stationary, the flap or flaps position themselves in a predetermined stopping position in which the said flap or flaps are offset by an angle comprised between 1 and 40° with respect to their sealing-off position.

8. The sealing-off device as claimed in claim 2, wherein when the motor vehicle is stationary, the flap situated lowest down positions itself in a predetermined stopping position resting against the fixed wall.
